(19) United States
(12) Patent Application Publication
(10) Pub. No.: US 2007/0216197 A1
(43) Pub. Date: Sep. 20, 2007

(54) Composite cargo floor structure having a reduced weight

(75) Inventor: Walter William Wuerfel III, Clayton, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Martin Marietta Materials, Inc.

(21) Appl. No.: 11/374,837

(22) Filed: Mar. 14, 2006

(51) Int. Cl. B62D 33/02

(52) U.S. Cl. 296/184.1

(57) ABSTRACT

The invention provides a composite cargo floor structure for providing a load-bearing surface on a cargo vehicle frame. More specifically, the invention provides composite cargo floor structure including a floor member composed of a first composite material and a support frame attached to the floor member, wherein the structural elements of the support frame are composted of a second composite material. The resulting composite cargo floor structure thus provides a cargo floor having a durable load-bearing capacity, a substantial resistance to harsh environmental conditions, and a reduced weight.

### FIELD OF THE INVENTION

The present invention is directed to a structural element and/or floor structure for a cargo-carrying vehicle. More specifically, the present invention provides a composite floor structure for a truck and/or trailer having a reduced weight, enhanced resistance to harsh environmental conditions, high strength, and high load-bearing capacity.

### BACKGROUND OF THE INVENTION

Flat-bed truck bodies and/or cargo trailers are often produced with an exposed frame portion upon which a floor structure is applied for carrying loads. Conventional floor structures produced for cargo vehicles are constructed from a frame of steel channels or I-beams overlaid with plywood sheet, wherein the steel tubing is affixed to the vehicle frame (via fasteners and/or welds) and wherein the plywood sheet serves as the cargo floor. In many cases, the steel tubing is welded to form a steel ladder frame that is bolted to the plywood sheet floor to form the floor structure.

The steel and plywood components of conventional cargo floor structures, while relatively easy to obtain and modify to form a robust cargo floor, suffer from several shortcomings. For example, the steel channels and/or I-beams (which are in many cases 3 inches tall) and plywood (which is often 1 inch or more thick) used to construct conventional floor structures are relatively heavy materials, and thus add to the empty weight of a cargo vehicle. Such extra weight reduces the fuel economy and decreases the effective cargo capacity of the cargo vehicle. The added empty weight of cargo vehicles equipped with conventional cargo floor structures also increases wear on vehicle components, such as suspension systems and/or tires. All of these issues may result in extra costs for operators of such cargo vehicles, especially in cases where such cargo vehicles are expected to carry relatively heavy cargo loads over long distances.

The steel and wood components of conventional cargo floor structures may also be especially vulnerable to the degrading influences of the weather and/or environmental conditions to which the floor structures may be exposed on a daily basis. For example, plywood floor structures may deteriorate due to rot, weather exposure, and/or insect infestation. Such deterioration may be especially prevalent where the vehicle is stored outdoors at a cargo depot and/or a cargo truck terminal for extended periods. In addition, the steel frame structure may rust. Frame rust may be particularly problematic in cargo vehicles operated in coastal environments (which may be subjected to salt water exposure) and/or cargo vehicles used in cold climates (where the frame may be subjected to exposure to road salt and/or slag used to treat roads covered in ice and snow).

Although conventional cargo floor structures suffer from the disadvantages outlined above, their use is still prevalent in flat-bed cargo vehicle applications primarily due to availability, relative ease of assembly and adjustability, and because the use of such conventional floor structures is relatively consistent and well-known. However, in light of the shortcomings of these conventional cargo floor structures, there exists a need in the art for cargo floor structures that: (1) minimize the empty weight of the cargo vehicles in which they are used while still providing a durable, heavy-duty load-carrying capacity; and (2) provide a cargo floor structure that may be utilized daily in harsh environmental conditions without suffering significant deterioration due to exposure to such harsh conditions.

### BRIEF SUMMARY OF THE INVENTION

The embodiments of the present invention satisfy the needs listed above and provide other advantages as described below. Embodiments of the present invention may include a composite cargo floor assembly. In some embodiments, the cargo floor assembly may comprise a floor member having a load-bearing surface and a mating surface opposite the load bearing surface, wherein the floor member may be formed substantially from a first composite material. The assembly may also comprise, in some embodiments, a support frame operably engaged with the mating surface of the floor member, wherein the support frame includes a first plurality of cross members extending in spaced relation in a first direction and a second plurality of cross members extending in spaced relation in a second direction such that the first and second plurality of cross members intersect and interconnect to form the support frame. In addition, the cross members may be formed substantially from a second composite material such that the cargo floor assembly has a reduced weight and an enhanced load-bearing capacity. In some embodiments, the floor assembly may further comprise an adhesive layer disposed between the mating surface of the floor member and the support frame for operably engaging the mating surface to the support frame to form the cargo floor assembly.

According to some other embodiments of the present invention, the first and second plurality of cross members forming the support frame may have a substantially rectangular cross-section. In some embodiments, the cross members may also be substantially hollow. Furthermore, the cross members may also, in some embodiments, define a plurality of apertures for receiving a corresponding plurality of fasteners for operably engaging the support frame with a frame of a vehicle (such as, for example, a flat-bed truck and/or cargo trailer).

Furthermore, in some assembly embodiments of the present invention, the second composite material of the first and second plurality of cross members may include, but is not limited to: a pultruded tubing material; a pultruded composite tubing; a composite tubing material comprising a polyurethane matrix and a plurality of E-glass fibers disposed within the polyurethane matrix; and combinations of such composite material components.

In some cargo floor assembly embodiments of the present invention, the first composite material of the floor member may include, but is not limited to: a fiber reinforced polymer material; a fiber reinforced polymer composite; and a solid laminate. In some embodiments, wherein the first composite material comprises a fiber reinforced polymer composite, the fiber reinforced polymer composite may include, but is not limited to: a pultruded sandwich panel comprising an upper skin and a lower skin and a core disposed substantially between the upper and lower skins; a vacuum-infused sandwich panel comprising an upper skin and a lower skin and a core disposed substantially between the upper and lower skins; a pultruded panel comprising an upper skin and a lower skin and a web material disposed substantially between the upper and lower skins; and combinations of such fiber-reinforced polymer composites.

In other assembly embodiments, the floor member may be substantially rectangular in shape and may further define at least one notch at a corner of the floor member for receiving a corner post adapted to extend substantially vertically from the load bearing surface of the floor member. Some additional embodiments may comprise a floor member having a substantially rectangular shape that may comprise at least one bracket extending substantially vertically from at least one edge of the floor member. In such embodiments, the bracket may be adapted to receive a side wall adapted to extend substantially vertically from the load bearing surface. Furthermore, in some such embodiments, the bracket may be integrally formed with the floor member.

Thus the various embodiments of the present invention provide many advantages that may include, but are not limited to: providing a relatively lightweight and durable composite cargo floor structure that may be easily affixed to a cargo vehicle frame; and providing a composite cargo floor structure that may be more resistant to deteriorating environmental forces when compared to conventional cargo floor structures. These advantages, and others that will be evident to those skilled in the art, are provided in the various embodiments of the present invention.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is an underside perspective view of a composite cargo floor assembly according to one embodiment of the present invention;

FIG. 2 is an underside view of a support frame and the mating surface of a floor member according to one embodiment of a composite cargo floor assembly of the present invention;

FIG. 3 is a top view of the load-bearing surface of a floor member according to one embodiment of a composite cargo floor assembly of the present invention; and

FIG. 4 is a perspective view of a composite cargo floor assembly including brackets operably engaged with the floor member for receiving a side wall adapted to extend substantially vertically from the load bearing surface, according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. The singular forms “a,” “an,” and “the” include plural referents unless the context clearly dictates otherwise.

Although the preferred embodiments of the invention described herein are directed to a composite cargo floor assembly for attachment to a truck body, it will be appreciated by one skilled in the art that the invention is not so limited. For example, embodiments of the composite cargo floor assembly of the present invention can also be incorporated into various other types of cargo vehicles including, but not limited to: cargo trailers, railcars, maritime cargo containers, and other cargo vehicles and/or containers.

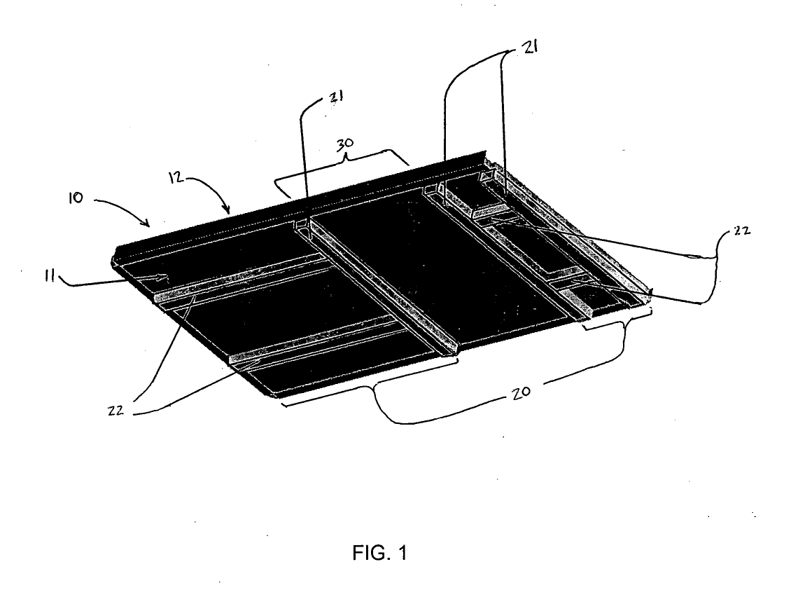

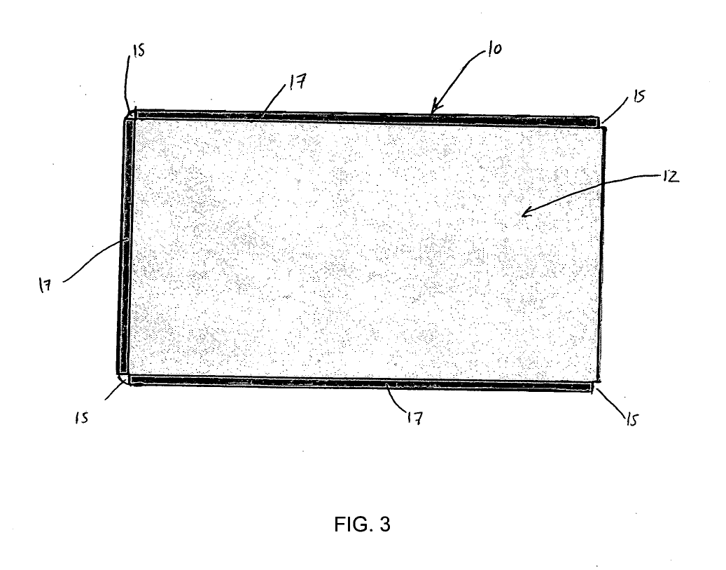

Referring to FIG. 1, one embodiment of the present invention provides a composite cargo floor assembly 10 comprising a floor member having a load-bearing surface 12 (see FIG. 3) and a mating surface 11 opposite the load bearing surface 12. According to some embodiments, the assembly 10 may also comprise a support frame 20 operably engaged with a mating surface 11 of the floor member. The support frame 20 may be operably engaged with the mating surface 11 of the floor member and may include a first plurality of cross members 21 extending in spaced relation in a first direction and a second plurality of cross members 22 extending in spaced relation in a second direction such that the first and second plurality of cross members 21, 22 intersect and interconnect to form the support frame 20.

According to some embodiments of the composite cargo floor assembly 10 of the present invention, the floor member may be formed of a first composite material that may include, but is not limited to: a fiber reinforced polymer material; a fiber reinforced polymer composite; and a solid laminate. In some embodiments, the fiber reinforced polymer composite may comprise a pultruded sandwich panel comprising an upper skin and a lower skin and a core material disposed substantially between the upper and lower skins. Other fiber reinforced polymer composites may include a vacuum-infused sandwich panel comprising an upper skin and a lower skin and a core material disposed substantially between the upper and lower skins.

Exemplary core materials of the first composite material may include, but are not limited to: wood, foam, and various types of honeycomb. Other core materials may also include, but are not limited to: web materials embedded in a thermosetting resin and fiber-reinforced polymer resin materials. The upper and lower skins may also comprise composite materials such as polymer resin materials including fiber reinforcing elements embedded therein. Exemplary polymer resin materials may include, but are not limited to: thermosetting resins, such as unsaturated polyesters, vinyl esters, polyurethanes, epoxies, phenolics, and mixtures thereof. The fiber reinforcing elements may include, but are not limited to: E-glass fibers, S-glass, carbon fibers, KEVLAR®, metal (e.g., metal nano-fibers), high modulus organic fibers (e.g., aromatic polyamides, polybenzamidazoles, and aromatic polyimides), and other organic fibers (e.g., polyethylene and nylon). Blends and hybrids of such materials may also be used as a reinforcing element. Other suitable composite materials that may be used as a reinforcing element within components of the first composite material may include, but are not limited to: whiskers and fibers constructed of boron, aluminum silicate, or basalt. Exemplary fiber reinforced panels that may be used as a composite floor member and methods of making such panels are disclosed in the following U.S. patents: U.S. Pat. Nos. 5,794,402; 6,023,806; 6,044,607; 6,108,998; 6,645,333; and 6,676,785, all of which are incorporated herein in their entirety. In addition, according to some embodiments of the composite cargo floor assembly 10 of the present invention, the floor member may also comprise a TRANSONITE® composite panel available from Martin Marietta Composites of Raleigh, N.C. According to some embodiments, the core of the sandwich panel used to form the floor member may be formed of a foam material with a plurality of fibers extending through the foam and connecting the two laminated skins secured to each opposing surface of the foam core.

According to some embodiments of the composite cargo floor assembly 10 of the present invention, the cross members 21, 22 of the support frame 20 may be formed of a second composite material that may include, but is not limited to: a pultruded tubing material; a pultruded and/or extruded composite tubing; a composite tubing material comprising a polyurethane matrix and a plurality of E-glass fibers disposed within the polyurethane matrix; and combinations thereof. According to various embodiments, the second composite material forming the cross members 21, 22 may comprise a variety of different polymer resin materials including, but not limited to: thermosetting resins, such as unsaturated polyesters, vinyl esters, polyurethanes, epoxies, phenolics, and mixtures thereof. The fiber reinforcing elements of the second composite material forming the cross members 21, 22 may also include, but are not limited to: E-glass fibers, S-glass, carbon fibers, KEVLAR®, metal (e.g., metal nano-fibers), high modulus organic fibers (e.g., aromatic polyamides, polybenzamidazoles, and aromatic polyimides), whiskers and fibers constructed of boron, aluminum silicate, or basalt, and other organic fibers (e.g., polyethylene and nylon).

Some composite cargo floor assembly 10 embodiments of the present invention may further comprise an adhesive layer disposed between the mating surface 11 of the floor member and the support frame 20 for attaching the mating surface 11 to the support frame 20 to form the cargo floor assembly 10. The adhesive layer may comprise one or more adhesive compounds that may include, but are not limited to: polyurethane adhesives and methacrylate adhesives. Furthermore, according to some embodiments, the various cross members 21, 22 of the support frame 20 may also be operably engaged with the floor member 20 via various types of fasteners, including, but not limited to: screws, bolts, rivets, toggle fasteners, and combinations thereof.

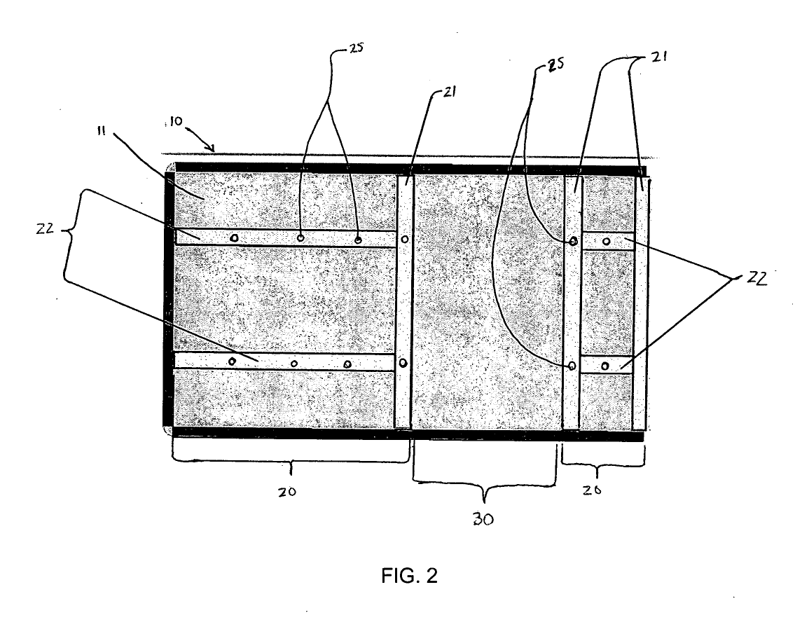

According to some embodiments, as shown generally in FIG. 1, the first and second plurality of cross members 21, 22 may intersect at substantially right angles and interconnect to form a ladder-shaped support frame 20. According to other embodiments, the first and second plurality of cross members 21, 22 may intersect at a selected angle (such as, for example 60 degrees) and interconnect to form a plurality of X-shaped, and/or V-shaped support frame 20 elements that may be operably engaged with the mating surface 11 of the floor member. Furthermore, as shown generally in FIGS. 1 and 2, the support frame 20 may be interrupted along a portion of the mating surface 11 of the floor member define an open channel 30 corresponding to the position of an axle or a pair of axles attached to a vehicle with which the composite cargo floor assembly 10 embodiments of the present invention may be operably engaged. As one skilled in the art will appreciate, the open channel 30 defined by the various portions and/or segments of the support frame 20 may be wide enough to accommodate 2 or more axles and/or any number or pattern of axles that may be present on a vehicle to which the composite cargo floor assembly 10 is applied.

The individual cross members of the first and second plurality of cross members 21, 22 may have various cross-sectional shapes. For example, according to some embodiments of the present invention (as shown generally in FIGS. 1, 2, and 4), the first and second plurality of cross members 21, 22 may have a substantially rectangular cross-section. According to other embodiments, the first and second plurality of cross members 21, 22 may also be configured to have a variety of different cross-sectional shapes that may include, but are not limited to: circular, oval, half-circle, polygons (having various numbers of sides), square, and combinations of the above-listed cross-sectional shapes. Furthermore, according to various embodiments of the present invention the first and second plurality of cross members 21, 22 may be substantially hollow so as to decrease the amount and weight of material required to form the support frame 20. Furthermore, as one skilled in the art will appreciate, the relative thicknesses of the material wall used to form the cross members may be optimized to provide an optimal strength-to-weight ratio.

Furthermore, as shown generally in FIG. 2, the first and second plurality of cross members 21, 22 may also define a plurality of apertures 25 for receiving a corresponding plurality of fasteners for operably engaging the support frame 20 with a frame of a vehicle with which the composite cargo floor assembly 10 may be operably engaged. For example, as shown in FIG. 2, the cross members 21, 22 may define a plurality of circular apertures 25 for receiving fasteners that may include, but are not limited to: bolts, rivets, screws, toggle fasteners, and combinations thereof. The apertures 25 may be defined in portions of the cross members 21, 22 corresponding substantially to corresponding apertures defined in a portion of a cargo vehicle frame such that the composite cargo floor assembly 10 of the present invention may be operably engaged with the cargo vehicle frame via the fasteners that may extend through the apertures 25 defined in the cross members 21, 22. In some embodiments, the apertures 25 defined by the cross members 21, 22 may also be threaded so as to be capable of receiving a threaded fastener such as a bolt and/or screw for operably engaging at least one embodiment of the composite cargo floor assembly 10 of the present invention with a cargo vehicle frame which may include, but is not limited to: a flat bed truck frame, a trailer frame, a flat bed railcar, and/or another cargo vehicle frame.

As shown generally in FIG. 3 the floor member of the composite cargo floor assembly 10 in some embodiments of the present invention may have a substantially rectangular shape corresponding to the approximate size and/or shape of a cargo vehicle frame with which the composite cargo floor assembly 10 is designed to be operably engaged. Furthermore, in some embodiments, the floor member may define at least one notch 15 at a corner thereof for receiving a corner post (not shown) adapted to extend substantially vertically from the load bearing surface 12 of the floor member. According to various embodiments, the notch 15 defined in the floor member may be formed to have a variety of different shapes corresponding substantially to a cross-sectional shape of a corner post to be received therein. For example, the notch 15 defined in at least one corner of the floor member may define shapes including, but not limited to: rectangular, circular, oval, polygonal, half-circular, quarter-circular, and/or combinations thereof.

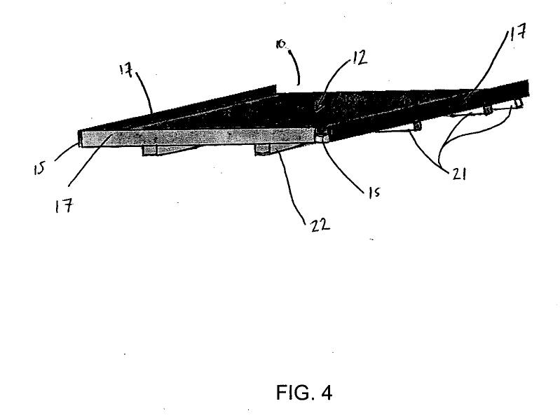

FIG. 4 shows another alternate embodiment of the composite cargo floor assembly 10 of the present invention, wherein the floor member comprises at least one bracket 17. According to some embodiments, the bracket 17 may include a first member attached to the floor member and extending laterally from an edge of the load-bearing surface 12 thereof. In some embodiments, the bracket 17 may also include a second member extending generally upward at a selected angle from the first member of the bracket 17 for receiving a side wall (not shown). For example, the second member of the bracket 17 may extend substantially vertically from at least one edge of the floor member as to be capable of receiving a side wall (not shown) adapted to extend substantially vertically from the load bearing surface 12 of the floor member. In some such embodiments, the bracket 17 may allow the assembly 10 of the present invention to be combined with wall structures to form an enclosed cargo-carrying structure. In some embodiments, the at least one bracket 17 may be integrally formed with the floor member and may comprise one or more of the first and/or second composite materials, as described above. For example, some embodiments of the floor member of the present invention having one or more brackets 17, as shown generally in FIG. 4, may be integrally formed, using heat, pressure, adhesive materials, and/or other composite material processing steps that will be appreciated by one skilled in the art such that the floor member and bracket 17 may be provided in substantially one piece, such that few or no fasteners may be required to form the integral floor member and bracket 17 sub-assembly. According to some other embodiments of the present invention, the bracket 17 may be operably engaged with one or more edges of the floor member via one or more fastener devices and/or adhesives which may include, but are not limited to: screws, bolts, rivets, toggle fasteners, epoxy adhesives and/or combinations thereof.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composite cargo floor assembly comprising:
a floor member having a load-bearing surface and a mating surface opposite the load bearing surface, the floor member being formed substantially from a first composite material;
a support frame operably engaged with the mating surface of the floor member, the support frame comprising a first plurality of cross members extending in spaced relation in a first direction and a second plurality of cross members extending in spaced relation in a second direction such that the first and second plurality of cross members intersect and interconnect to form the support frame, the cross members being formed substantially from a second composite material.

2. The assembly according to claim 1, wherein the first and second plurality of cross members have a substantially rectangular cross-section.

3. The assembly according to claim 1, wherein the first and second plurality of cross members are substantially hollow.

4. The assembly according to claim 1, wherein the first and second plurality of cross members define a plurality of apertures for receiving a corresponding plurality of fasteners for operably engaging the support frame with a frame of a vehicle.

5. The assembly according to claim 1, wherein the first composite material comprises at least one of:
a fiber reinforced polymer material;
a fiber reinforced polymer composite;
a solid laminate; and
combinations thereof.

6. The assembly according to claim 5, wherein the fiber reinforced polymer composite comprises at least one of:
a pultruded sandwich panel comprising an upper skin and a lower skin and a core disposed substantially between the upper and lower skins;
a vacuum-infused sandwich panel comprising an upper skin and a lower skin and a core disposed substantially between the upper and lower skins;
a pultruded panel comprising an upper skin and a lower skin and a web material disposed substantially between the upper and lower skins; and
combinations thereof.

7. The assembly according to claim 1, wherein the second composite material comprises at least one of:
a pultruded tubing material;
an extruded composite tubing;
a composite tubing material comprising a polyurethane matrix and a plurality of E-glass fibers disposed within the polyurethane matrix; and
combinations thereof.

8. The assembly according to claim 1, further comprising an adhesive layer disposed between the mating surface of the floor member and the support frame for adhering the mating surface to the support frame to form the cargo floor assembly.

9. The assembly according to claim 8, wherein the adhesive layer comprises adhesive compounds selected from the group consisting of:
polyurethane adhesives;
methacrylate adhesives; and
combinations thereof.

10. The assembly according to claim 1, wherein the floor member defines at least one notch at a corner thereof for receiving a corner post adapted to extend substantially vertically from the load bearing surface.

11. The assembly according to claim 1, wherein the floor member comprises at least one bracket extending substantially vertically from at least one edge thereof for receiving a side wall adapted to extend substantially vertically from the load bearing surface.

12. The assembly according to claim 11, wherein the at least one bracket is integrally formed with the floor member.

13. A cargo vehicle comprising the composite cargo floor assembly according to claim 1.
